(19) United States
(12) Patent Application Publication
(10) Pub. No.: US 2005/0043079 A1
(43) Pub. Date: Feb. 24, 2005

(54) System and method for assigning prizes in a bingo-type game

(76) Inventor: Sming Huang, Monmouth Junction, NJ (US)

Correspondence Address: MICHAEL BEST & FRIEDRICH LLC, 401 NORTH MICHIGAN AVENUE, SUITE 1900, CHICAGO, IL, 60611-4212, US

(21) Appl. No.: 10/644,366

(22) Filed: Aug. 20, 2003

(51) Int. Cl. G06F 17/00; A63F 13/00; G06F 19/00

(52) U.S. Cl. 463/19

(57) ABSTRACT

A system and method for assigning the prizes in a bingo game depending on the number of balls drawn at the end of the game. An electronic bingo gaming system includes a game ID manager and a predetermined number associated of card managers. The game ID manager generates game IDs defining a random ball drawing sequence and pattern of card win spots. The game ID manager transmits the selected game ID to the card manager which generates player and opponent cards. The game ID manager “calls off” each drawn ball and the card manager displays the drawn ball in a drawn ball sequence display area and marks any matched spots on the displayed cards. The ball drawing continues until the player or an opponent wins by marking all win spots. The game win probabilities and payout percentages are determined based on the count of balls at the conclusion of the game.

### FIELD OF THE INVENTION

The present invention relates to bingo-type games. More particularly, the invention relates to a system and method for assigning prizes in bingo-type games.

### BACKGROUND OF THE INVENTION

Casino gaming is currently one of the highest profile growth industries in the United States. Casino gamers lured by the opportunity to win cash, prizes, and bulging jackpots lay down billions of dollars annually. In an effort to attract new gamers and tempt traditional gamers with new exciting options, casinos are supplementing their traditional game offerings such as Blackjack, Craps, and Roulette with electronic games. Electronic games are now offered in many forms including slot machines, card games such as Blackjack and Poker, dice games, and numerous variations and combinations of the aforementioned. To keep the gamer's interest, these electronic games often incorporate unique lights, music, video displays, and interactive or competitive elements. In contrast, electronic lottery-type games such as Bingo or Keno progress slowly, offer fixed payouts, and do not present visual stimulation or the perception of competition to the gamer.

To increase player interest in a bingo-type game, U.S. Pat. No. 6,569,017 to Enzminger et al. for “Method for Assigning Prizes in Bingo-type Games” issued May 27, 2003 discloses a method for assigning a prize based on achieving one of several winning target patterns (e.g., a straight line, a diagonal line, the letter “X”). The Enzminger et al. method determines the probabilities in achieving a number of target patterns on a bingo card. Next, pattern sets (e.g., a target pattern, or group of target patterns) are associated with prize levels to give a desired prize distribution. Target patterns and associated probabilities are then mapped to different pattern sets to give the desired prize level probability. In this way, Enzminger et al. attempt to overcome the fixed payout disadvantage of prior art Bingo games, but fail to provide a fundamentally improved user experience because payouts are simply defined by the pattern sets at the onset of each game session.

However, to keep a Bingo player's interest or attract new players, the game must offer more than a variety of different prize distributions. Moreover, Enzminger et al. teach a method with a fixed number of drawn balls. Therefore, the method violates a fundamental rule of Bingo in which there must be at least one winner. Additionally, the method relies on the player remembering a number of different patterns which make it difficult to recognize when the player has won. What is needed is to offer a player the perception of challenge and competition along with a method of assigning prizes that is simple to indicate and easily understood.

Therefore, it is an object of the invention to provide a system and method for assigning prizes in bingo-type games that overcomes the shortcomings associated with the prior art. Aside from the method of assigning prizes, the present invention provides for a way to make the bingo gaming experience more exciting for a player by presenting the perception of challenge and competition.

### SUMMARY OF THE INVENTION

The present described system and method provides for improved user experience in connection with bingo-type games. Bingo games traditionally have fixed predetermined prizes. Therefore, to enhance a bingo game's appeal, a system and method for assigning prizes based on the number of balls drawn for a player to win is disclosed. Additionally, the disclosed system and method includes elements that provide excitement and stimulation to a player such as competitive play with opponents.

An electronic bingo gaming system includes a game ID manager and a predetermined number associated of card managers. The game ID manager is connected to at least one card manager, and there is no maximum number of card managers that can be connected to a game ID manager. The game ID manager may also be linked to other game ID managers. The game ID manager functions in a server capacity to its associated card managers and is responsible for generating game IDs. Each generated game ID defines a random ball drawing sequence and pattern of card win spots (e.g., a line, a diagonal line, four corners). The game ID manager transmits a game ID to its associated card managers which generate the player and opponent card or cards. The player and opponent cards are data structures that are indicated on the card manager display with numbers as in traditional Bingo, or may alternatively include sets of symbols or indicia.

A player can choose to play one or more game cards by inserting coins, cash, credit card, or other cashless payment into the card manager. The player can determine the payout multiplier by selecting the number of credits to play per game. The player may also be able to select one or more of the following: card win spots, number of opponents and game cards per opponent, and game odds table. The card manager transmits the player selections to the game ID manager and receives a game ID in response. The card manager generates and displays the player and opponent cards with a pattern of win spots. A winning payout table corresponding to the game attributes (e.g., # player cards, # opponent cards, win spots, etc.) is also displayed dynamically or statically using a video display or mechanical device. The game operator may easily calibrate the game payout rate by varying the game attributes to maximize the players' interest and excitement.

The game ID manager “calls off” each drawn ball by transmitting the selection to the card manager. The card manager displays the drawn ball in a drawn ball sequence display area and marks any matched spots on the displayed player and opponent cards. As the ball drawing progresses, the card manager may include an indicator in the form of slot machine-type reels or a display to represent the size of the game payout. This game payout indicator adds an exciting element to the player and also improves the “feel” of the game by keeping the player appraised of the ongoing game status. The ball drawing continues until the player or opponent wins by marking all win spots.

Additional embodiments of the game may include a progressive jackpot where a predetermined percentage of every play is contributed to a jackpot. Since a number of game ID managers may be linked over a geographic area via a WAN, the progressive jackpot can grow quickly and substantially due to contributions from the multiple card managers. The game ID managers administer jackpot additions and payouts in communication with the card managers. This progressive jackpot offering adds an element of excitement and competition to a player.

### BRIEF DESCRIPTION OF THE DRAWINGS

FIG. 1 illustrates a distributed electronic bingo-type game system.

FIG. 2 illustrates a block diagram showing a configuration for a game controller of the distributed electronic bingo-type game system of FIG. 1.

FIG. 3 illustrates a block diagram showing a configuration of a game terminal of the distributed electronic bingo-type game system of FIG. 1.

FIGS. 4A through 4C are flow diagrams illustrating a method of playing a bingo-type game on the distributed game network of FIG. 1.

FIGS. 5A through 5C show exemplary game terminal displays illustrating the game play of a bingo-type game of FIG. 1.

### DETAILED DESCRIPTION OF THE PREFERRED EMBODIMENTS

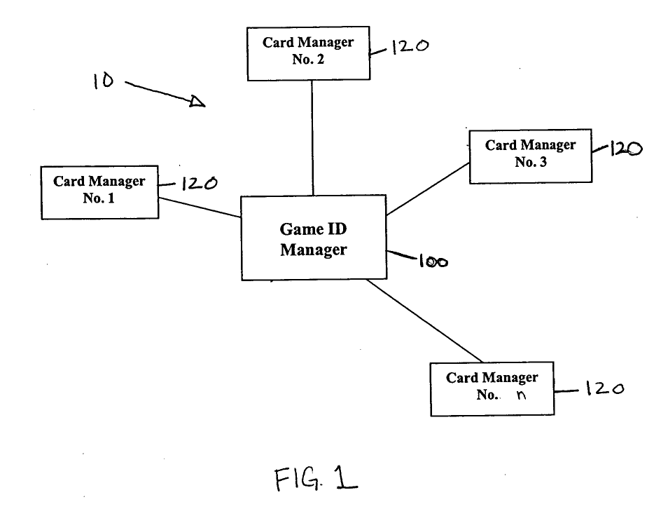

Referring now to the drawings and especially FIG. 1, a distributed electronic bingo-type game system 10 is shown. The distributed bingo-type game system 10 includes a game controller 100 (hereinafter “game ID manager”), and one or more game terminals 120 (hereinafter “card managers”) linked to communicate with the game ID manager 100. The game ID manager 100 is responsible for supervisory functions of the distributed bingo-type game system 10 and may be connected to any number of card managers 120. The game ID manager 100 may also be interconnected with other game ID managers to create a wide area distributed game system.

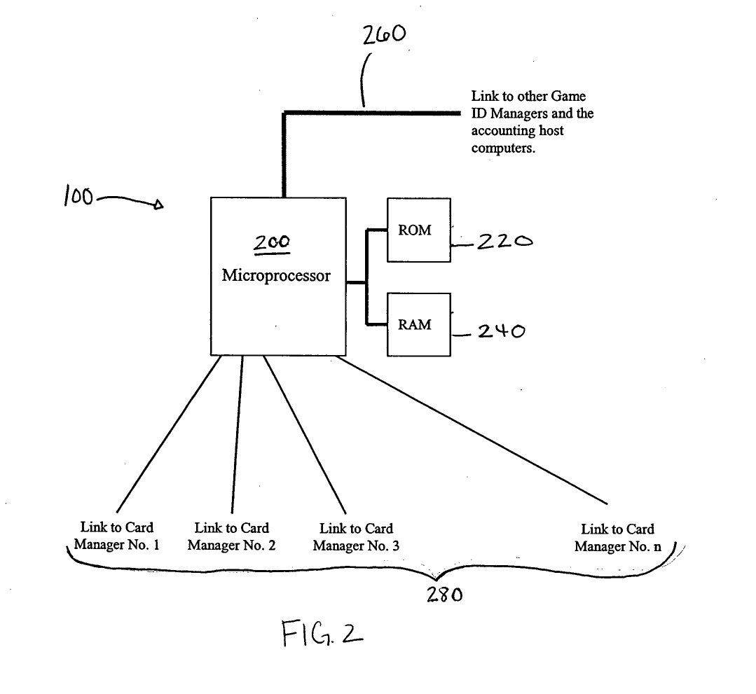

The game ID manager 100 is responsible for generating game IDs, each game ID defines a particular game with a ball drawing sequence and game card win spot arrangement. As shown in FIG. 2, the game ID manager 100 includes a microprocessor 200, read-only memory (RAM) 220, random access memory (RAM) 240, and links 280 to its associated card managers 120. The game ID manager 100 may also be linked to other game managers via link 260. Links 260 and 280 may be physical (wired) links if the game ID manager 100 and card managers 120 are located in proximity to each other. Alternatively, if the game ID manager 100 and card managers 120 are not co-located, they may be linked by dial up modems, local area network (LAN), wide area network (WAN), or virtual private network (VPN). In response to a game request from a card manager 120 over link 280, the game manager 100 transmits one of a number of stored game IDs from its memory to the card manager 120. Game ID microprocessor 200 may also include a random number generator for generating and transmitting a sequence of drawn indicia, (e.g. traditional bingo balls numbered 1 to 75), to the card managers 120. The game ID manager microprocessor 200 may also administer a progressive jackpot in which a fixed percentage of each game at each card manager has contributed to a jackpot, which accumulates until a player satisfies a condition of winning the jackpot.

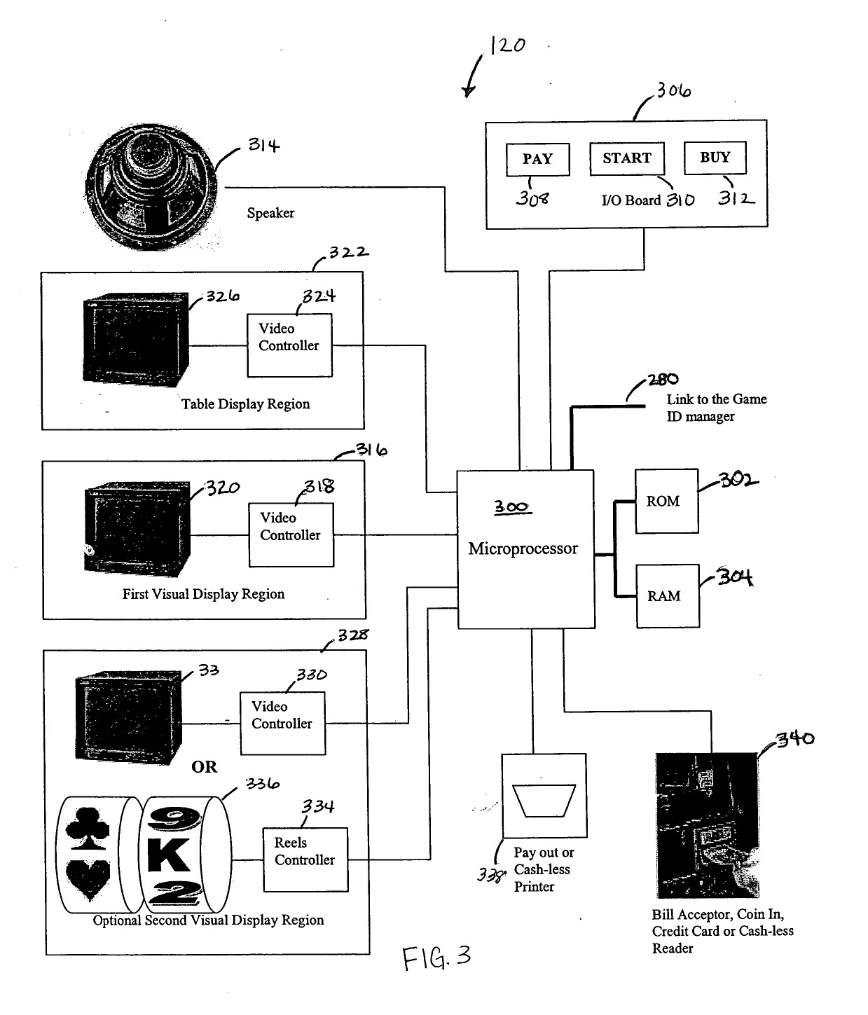

Card manager 120 serves as a game interface for a player. As shown in FIG. 3, the card manager 120 includes a player control interface 306 for requesting a game and selecting various game options. The control interface 306 includes buttons or selectors 308, 310, and 312 which respectively request winning payout, start a new game, and select the number of credits to play for each new game. The control interface 306 is preferred to be a touch-sensitive screen, but alternatively may include mechanical buttons or switches. In response to a player requesting a game, card manager microprocessor 300 communicates with game ID manager 100 over link 280. In response to the game request the card manager 120 receives a game ID from the game ID manager 100. Having received a game ID from the game ID manager 100, the card manager microprocessor 300 generates one or more game cards defined by a data structure.

Each game card data structure includes an arrangement of one or more win spots determined by the game ID manager 100. Each spot of the spot arrangement has an indicia assignment chosen by the card manager microprocessor 300. Indicia assigned to the game card data structure by the card manager microprocessor 300 may be randomly generated, or alternatively, may be stored in the card manager RAM 302 or ROM 304 as a data structure mask.

The game cards are displayed on the card manager first visual display region 316 which includes a video controller 318 and display terminal 320. The first visual display region 316 may display additional information about the game, including the game ID number, number of player credits, number of credits played, and player winnings. If a progressive jackpot is included in the game system, the jackpot total may also be displayed in this area. The displayed game card may be a game card with a five-by-five matrix of number, as in traditional bingo, or alternatively may be any shape with a number of spots and indicia assignments, the indicia including alphanumeric characters, symbols or other.

As a game starts, the game ID manager 100 transmits an ordered sequence of draw indicia to its card managers 120 via the card manager links 280. The transmitted draw indicia correspond to indicia on the displayed game cards dealt to the player and other displayed game cards indicated on the card manager first visual display region 316. Drawn indicia are displayed on the card manager indicia table display region 322 which includes a video controller 324 and display terminal 326. The indicia table display region 322 displays the draw indicia as they are received from the game ID manager 100 in the order that they were received. The indicia table display region 322 displays discrete prize levels corresponding to ranges of drawn indicia required to match all of the win spots on a game card. It is obvious that more valuable prizes are assigned to an initial range of draw indicia since the probability of covering a given number of win spots with the first few drawn indicia is quite low.

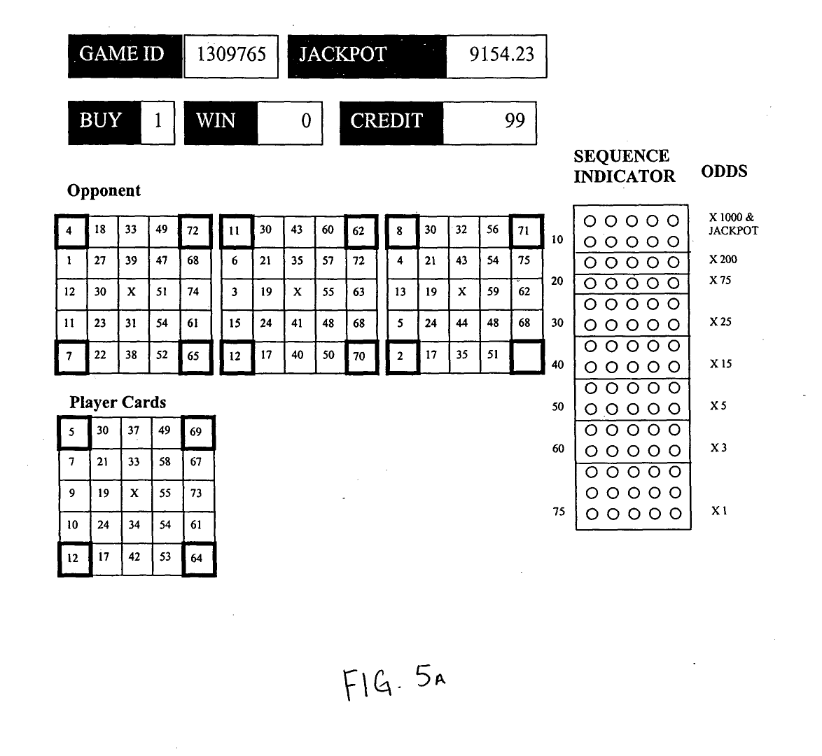

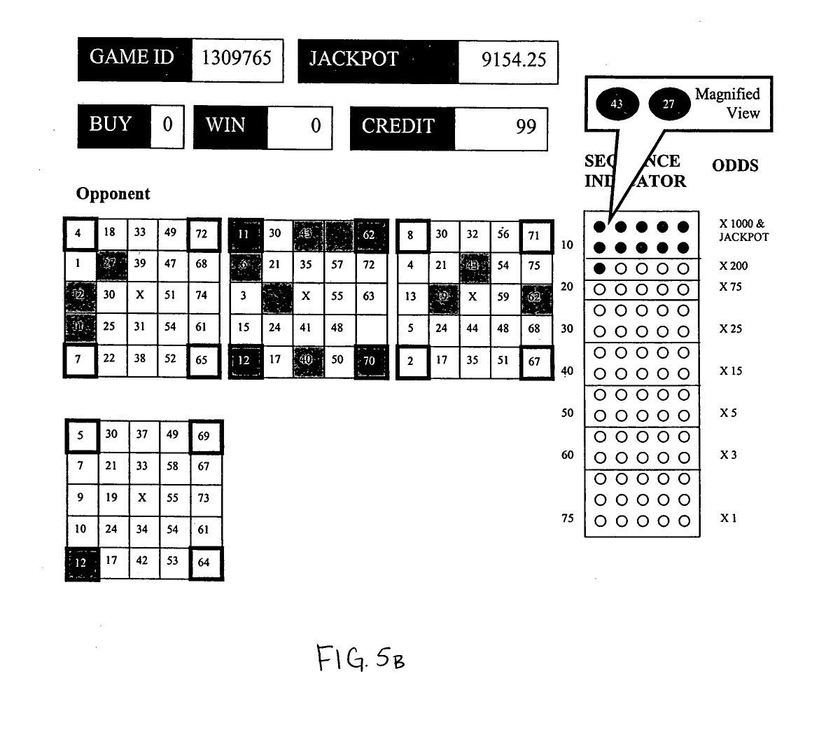

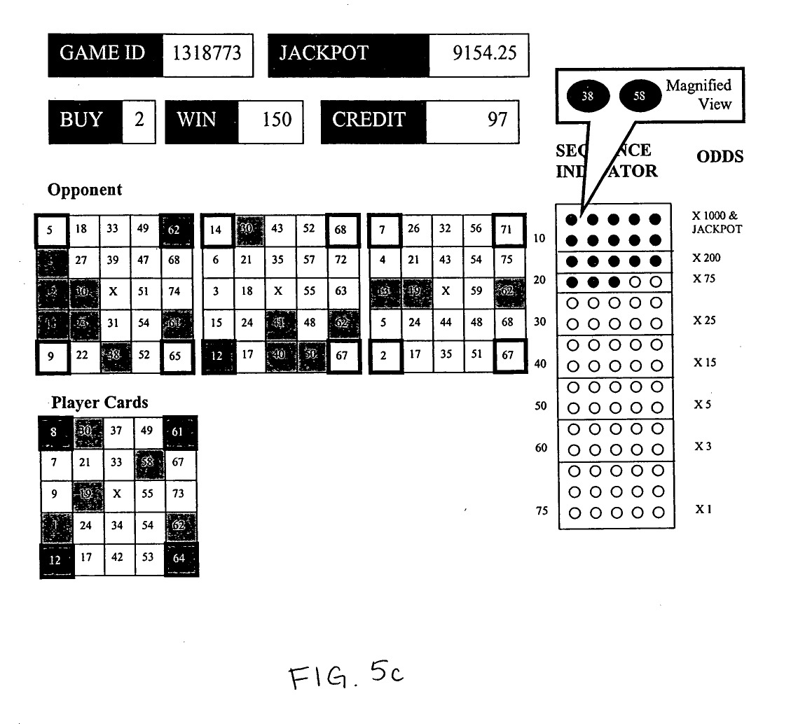

For example, the player game card shown in FIG. 5A includes four win spots highlighted in bold outline. The indicia table display region showing the indicia draw sequence defines ranges of indicia (e.g., 1 through 10, 11 through 20, etc.), and a corresponding winning payout for each range of indicia. One intuitively understands that the probability of marking the four win spots with the first four drawn indicia is very low, consequently, a large prize payout is associated with completing the marking of win spots in the initial range of drawn indicia. Assuming that this game is traditional bingo, a set of 75 balls (i.e. indicia) is associated with the game, 25 of which are assigned to any one card at a time. Therefore, it is assured that at least one player will win the game before all of the 75 balls are drawn. Since the probability of matching the win spots increases as more indicia are drawn in the draw sequence, the corresponding winning payout decreases accordingly (e.g., payout for the final range of indicia of the draw sequence corresponding to bingo balls 61 through 75 is one-for-one).

To determine the winning payout corresponding to a range of draw indicia, the card manager 120 first determines the prize levels and game payout rate. The game operator may select any number of prize levels for the game. An example game prize level and payout rate is shown in Table 1 below where the Payout Percentage for each prize level is calculated by:

$$PPD ( m : n ) = \frac{( BP ( n ) - BP ( m - 1 ) )}{TC} * O * PC$$

where BP(n) is the Bingo win probability after n indicia are drawn, O is the prize level winning payout, TC is the total number of cards dealt in a game, and PC is the total number of cards dealt to a player. The Bingo win probability after n indicia are drawn is calculated by:

$$BP ( D ) = \frac{( D ) !}{( D - W ) !} \frac{( T - W ) !}{T !}$$

where D is the count of draw indicia to win a bingo game, W is the number of spots in the arrangement of spots, and T is the total number of draw indicia (e.g., 75 for traditional Bingo). The sum of the payout percentages gives the game payout rate.

TABLE 1-3
Opponent Cards & 1 Player Card, 6-Win-Spots

| # Of Balls Drawn | | | |
|---|---|---|---|
| To BINGO | Payout | BINGO Probability | Payout Percentage |
| ˜20 | 2000 | 0.019249149% | 9.624574548% |
| 21˜25 | 500 | 0.068702974% | 8.587871795% |
| 26˜30 | 100 | 0.206930836% | 5.173270898% |
| 31˜35 | 50 | 0.511217372% | 6.390217151% |
| 36˜40 | 25 | 1.100131581% | 6.875822378% |
| 41˜SO | 10 | 5.985472256% | 14.963680640% |
| 51˜60 | 5 | 16.971213931% | 21.214017413% |
| 61˜75 | 1 | 75.137081902% | 18.784270475% |
| Payout Rate | | | 91.613725299% |

TABLE 2-3
Opponent Cards & 2 Player Cards, 6-Win-Spot

| # Of Balls Drawn | | | |
|---|---|---|---|
| To BINGO | Payout | BINGO Probability | Payout Percentage |
| ˜20 | 2000 | 0.019249149% | 7.699659639% |
| 21˜25 | 500 | 0.068702974% | 6.870297436% |
| 26˜30 | 100 | 0.206930836% | 4.138616718% |
| 31˜35 | 50 | 0.511217372% | 5.112173721% |
| 36˜40 | 25 | 1.100131581% | 5.500657903% |
| 41˜50 | 10 | 5.985472256% | 11.970944512% |
| 51˜60 | 5 | 16.971213931% | 16.971213931% |
| 61˜75 | 1 | 75.137081902% | 15.027416380% |
| Payout Rate | | | 73.290980239% |

If a player elects to play multiple game cards, the game variables need to be changed by the game so the game payout rate remains relatively constant. Table 2 shows an example payout percentage and game payout for a player with two game cards. If a player selects to play two game cards, and all other game variables are held constant, the game payout drops from 91.6% to 73.3%. Since a payout rate below 90% would be frustrating to a player and thus undesirable, the game may increase the payout rate by varying the winning payout per prize level, number of win spots, or both if a player elects to play multiple game cards.

TABLE 3-3
Opponent Cards & 2 Player Cards, 5-Win-Spot Cards

| # Of Balls Drawn | | | |
|---|---|---|---|
| To BINGO | Payout | BINGO Probability | Payout Percentage |
| ˜20 | 2000 | 0.089829362% | 35.931744981% |
| 21˜25 | 500 | 0.218003070% | 21.800306963% |
| 26˜30 | 100 | 0.517839854% | 10.356797083% |
| 31˜35 | 50 | 1.055228487% | 10.552284872% |
| 36˜40 | 25 | 1.931563051% | 9.657815253% |
| 41˜50 | 10 | 8.463520437% | 16.927040875% |
| 51˜60 | 5 | 19.367729682% | 19.367729682% |
| 61˜75 | 1 | 68.356286056% | 13.671257211% |
| Payout Rate | | | 1.382649769 |

TABLE 4
Opponent Cards & 2 Player Cards, 6-Win-Spot

| # Of Balls Drawn | | | |
|---|---|---|---|
| To BINGO | Payout | BINGO Probability | Payout Percentage |
| ˜20 | 2000 | 0.019249149% | 7.6996599639% |
| 21˜25 | 500 | 0.068702974% | 6.870297436% |
| 26˜30 | 200 | 0.206930836% | 8.277233436% |
| 31˜35 | 100 | 0.511217372% | 10.224347442% |
| 36˜40 | 45 | 1.100131581% | 9.901184225% |
| 41˜50 | 15 | 5.985472256% | 17.956416768% |
| 51˜60 | 5 | 16.971213931% | 16.971213931% |
| 61˜75 | 1 | 75.137081902% | 15.027416380% |
| Payout Rate | | | 92.927769257% |

If the winning payout per prize level is desired to remain constant, the game may vary the number of win spots on the game cards. Table 3 shows a payout percentage distribution and payout rate for a game where the game cards have five win spots. By decreasing the number of win spots per card from six to five, the game is easier to win and has a payout rate of more than one hundred percent. Now, if the game generated cards with five win spots thirty percent of the time, and game cards with six win spots the remainder of the time, the overall game payout rate will be 92.8% (0.3*1.38+0.7*0.733, using payout rates shown in Table 2 and 3), thereby keeping the game payout rate relatively constant.

Alternatively, if the number of spots per game card is desired to remain constant, the game may vary the prize payout per prize level. Table 4 shows a payout percentage distribution and payout rate for a game where the player selects to play two game cards each with six win spots. Since the quantity of win spots is desired to be constant, the game may now vary the prize payouts per each prize level to achieve an acceptable game payout rate. By comparing Table 2 and 4, by increasing the prize payouts for the middle four ranges, the game has increased the game payout rate from 73.3% to 92.9%.

As is obvious to those skilled in the art, in addition to the above described embodiments for maintaining a relatively constant game payout rate, a combination of the two may be employed in which the game card win spots and prize payouts are varied.

The card manager 120 may also include a speaker 314 for playing music or broadcasting synthesized speech during game play. Card manager 120 may also include a means to accept game payment or wagers via a bill acceptor 340, which may alternatively or additionally include means to accept coins, credit cards or payment vouchers. In connection with player control 306 pay button 308, a payout means 338 may include a voucher printer or means to distribute coins or tokens.

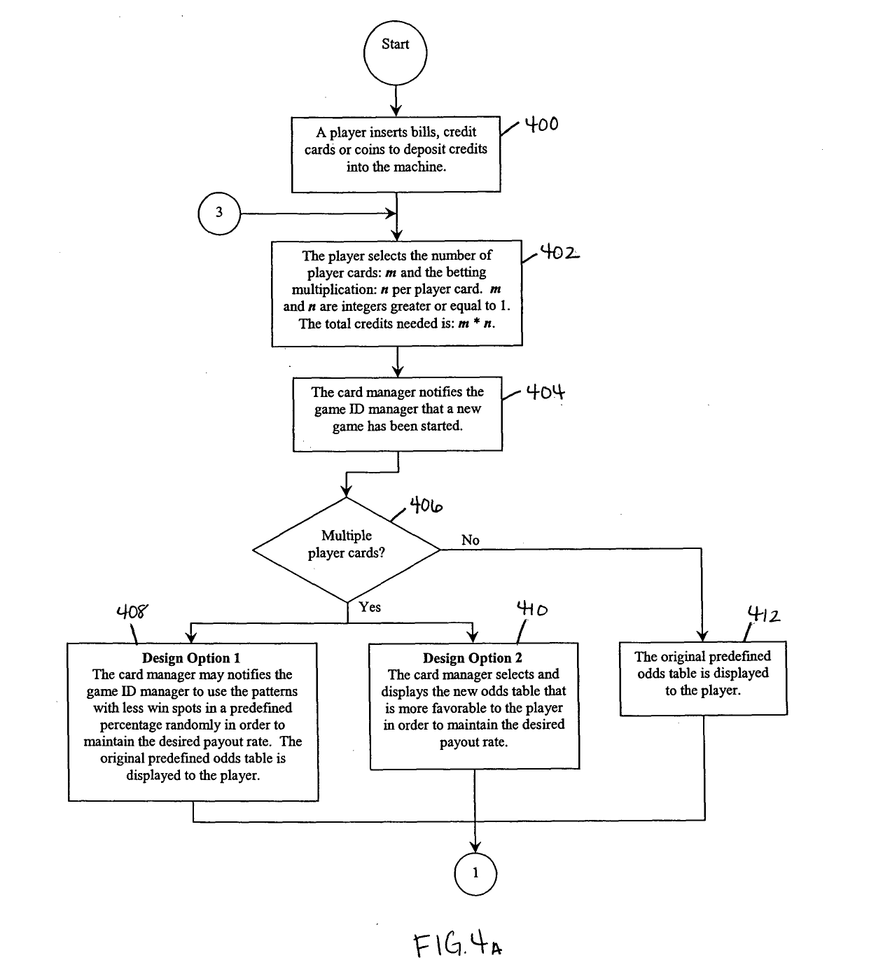

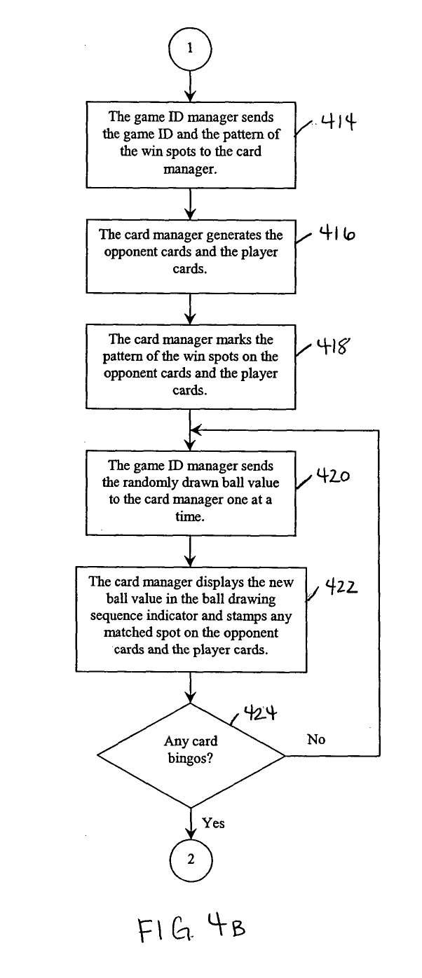

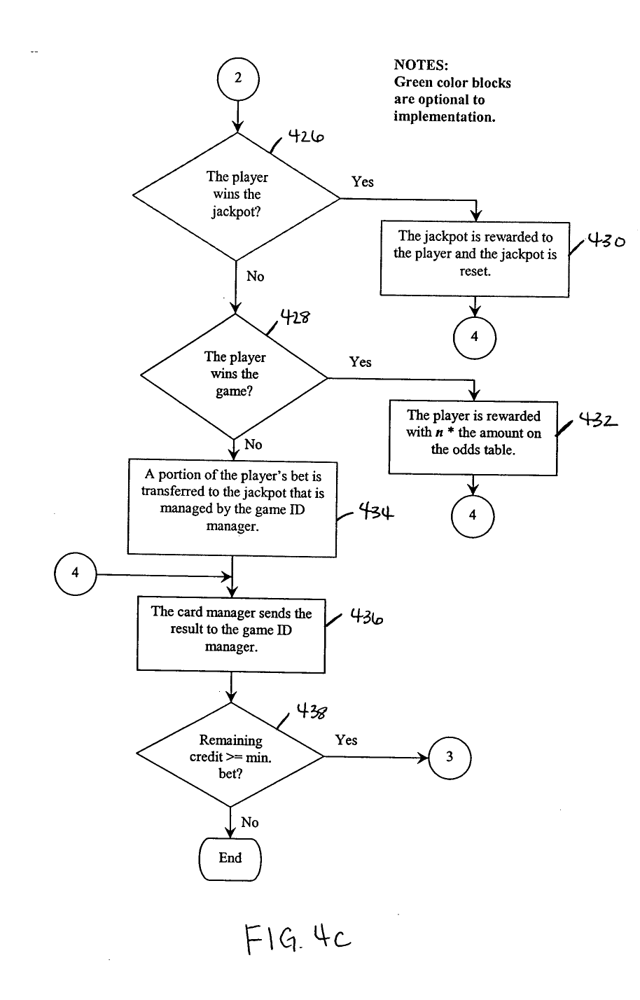

Referring now to FIGS. 4A through 4C, a method of playing an electronic bingo-type game on a distributed bingo game system wherein prizes are assigned according to the number of draw indicia drawn to mark a win spot arrangement on a game card is shown. A player initiates a game by inserting bills, credit cards, coins or vouchers into the card manager 120 in block 400. The player selects the number of player cards and the number of credits played per card in block 402 after which the card manager transmits the player specific game information to the game ID manager 100 via link 280. In block 406 game ID manager 100 determines if the player is requesting multiple game cards, and if the player requests only one card, a pre-defined prize tag is displayed to the player in block 412. If the player requests multiple game cards in block 406, the game ID manager may direct the card manager to either modify the win spot arrangement or number of win spots or to vary the winning payouts associated with the ranges of drawn indicia so that a predetermined desired payout rate is maintained. In block 402 when the player selects a game options, including number of credits and number of cards to play, the player may also be able to select other options, such as the number of win spots, the arrangement of win spots, the number of opponents, the number of cards per opponent, or the winning payout of each prize level. In accordance with the player's selected game options in block 402, the game ID manager instructs the card manager to maintain the game payout rate by selecting option 1 in block 408 or option 2 in block 410.

In FIG. 4B, the game ID manager transmits a game ID and pattern of win spots to the card manager in block 414 and having received the game ID and win spot arrangement, the card manager generates the player and opponent cards displaying them on its first visual display region with assigned indicia in block 416. Next, the game ID manager transmits an ordered sequence of indicia to the card manager. The indicia corresponding to the card indicia, and when a received indicia the card manager matches indicia assigned to the game card, that particular indicia is marked. It is important to note that each game card includes indicia and win spot indicia, and winning the game is accomplished by marking all of the win spots on at least one card. The game cards are assigned with a win spot arrangement in 418 after which the randomly drawn indicia are transmitted from the game ID manager to the card manager in block 420. The card manager displays the new draw indicia in the draw indicia sequence table and marks any matched indicia on the displayed game cards in block 422. In decision block 424, the game ID manager polls it card managers to see if any player has completed the marking of the win spot arrangement, and if there is no winner, the game ID manager continues to send randomly drawn indicia to the card managers, which continue to display the new indicia values and mark any match spots in blocks 420 and 422. The process continues until one or more players complete the marking of the win spot arrangement in block 424.

In FIG. 4C, the winning player is identified by the card manager to the game ID manager, and if the game includes a progressive jackpot, the card manager determines if the player has won the jackpot in block 426. The jackpot is rewarded to the player and the jackpot is reset in block 430 after which the player may choose to play another game or cash out their winnings. If a progressive jackpot is not won or is not included in the game, the winning player is identified in block 428 and in block 432 the player is paid an amount corresponding to the number of credits played multiplied by the winning payout associated with the range of draw indicia that were required to match all of the spots on a player's winning game card. The player may then choose to play the game again or cash out their winnings.

If instead an opponent wins the game and the player loses, if the game incorporates a progressive jackpot, a portion of the player's bet is transferred to the jackpot, which is administered by the game ID manager in block 434 and the card manager sends the game results to the game ID manager in block 436. In block 438 the card manager determines if the player has adequate credits to play another game. If so, the player may again select game options in FIG. 4A block 402, otherwise the game ends.

An example of the method illustrated in FIGS. 4A through 4C is detailed hereafter. Referring to FIGS. 5A through 5C, a traditional bingo electronic game is shown. The game includes one player card and three opponent cards which can be three separate opponents or one opponent with three game cards, and a pre-assigned winning pattern of four corner locations on each card. A ball sequence indicator is shown along with an associated prize payout for each prize level defined by a range of balls. As shown in FIG. 5A, no balls have been drawn, no cards have been marked and the game has just begun. The game ID associated with this game is 1309765 and the initial progressive jackpot is 9154.23. The game progresses with a ball draw sequence of balls marked with the numbers 43, 27, 11, 6, 60, 12, 40, 70, 19, 23, and 62 in that order. As shown in FIG. 5B, a ball sequence is shown in the sequence indicator and the game has ended when the eleventh ball having the value of 62 is drawn. One of the opponent's cards has completed the marking of all four win spots in the corners of the card. The player does not win, and a predetermined fixed portion of the player's buy amount is reported to the game ID manager which adds that amount to the jackpot, which is now 9154.25. The new jackpot value is transmitted to all of the game ID managers card managers. The opponent with the winning card, if that opponent were a network opponent and not virtual, would receive a winning payout of 200 multiplied by the number of credits played for that card.

The player selects to play a game again, buying a game with two credits. The new game ID is 1318773 and the player's remaining credit is 97. The game progresses with a ball drawing sequence of 38, 58, 11, 8, 64, 12, 40, 70, 19, 23, 62, 1, 13, 20, 30, 41, 50, and 61. The game ends when the eighteenth ball that has the value of 61 is drawn and the player card has bingo, having completed the marking of the four corner spots on the card. The player wins the game and the winning payout is calculated as the number of credits played for that game multiplied by the winning payout for the associated range of draw indicia to mark all of the winning spots. The player wins 150 credits.

In contrast to the above examples where a player competes with opponents, a player may select to play the game alone. If the game were traditional Bingo, a sole player would be assured to win every game by the time all the balls were drawn. Since having a winning player every game is undesirable to a game system operator, the game payout rate may be changed by assigning a zero prize payout to certain ranges of draw indicia. This way, in keeping with traditional Bingo, there may still be a winner for each game, but the winning prize payout may be zero. For example, prize payouts of zero may be assigned for draw indicia in the draw sequence after sixty balls are counted. Therefore, if the player marks all spots in the spot arrangement before sixty balls are counted, a non-zero prize is won, otherwise the prize won is zero.

In an alternative embodiment of the game system, a game ID manager may generate game IDs continuously. For example, ten per second, each game ID has an associated pre-defined drawing sequence of indicia. A database correlating the game ID and the drawing sequence of indicia is stored in each card manager. By combining a large pool of game IDs, for example, ten million, and rapid game ID generation, it is impossible for a player to predict a pre-defined drawing sequence for a specific game ID. This embodiment can simplify the communication between a game ID manager and its card manager. A game ID manager need only broadcast the generated game ID and, therefore, there is no drawn indicia information in the communication channel, and the game ID manager need not receive information from its card manager. In this way, the card manager does not need a random number generator and the game ID received by the card manager at the moment a player starts a game is used to retrieve the predetermined ball draw sequence.

1. A method for assigning prizes in a bingo-type game comprising the steps of:
assigning an arrangement of one or more spots on each of a plurality of game cards, each spot on each of the plurality of game cards having an indicia assignment;
dealing one or more of the plurality of game cards to a first player;
drawing a random sequence of draw indicia;
marking each spot on each of the plurality of game cards dealt to the first player having the indicia assignment corresponding to the draw indicia;
completing the marking of the arrangement of the spots on at least one game card of the first player;
counting the number of draw indicia from the drawing step required to complete the marking of the arrangement of the spots on the at least one game card of the first player; and
identifying a game prize based on the counted number of draw indicia.

2. The method of claim 1 wherein the identifying step comprises:
determining a plurality of ranges of counted draw indicia, each of the plurality of ranges corresponding to a prize level further comprising a winning payout and payout percentage, wherein the sum of the payout percentages corresponding to each of the prize levels gives the game payout rate.

3. The method of claim 2 further comprising:
in the dealing step, dealing one or more of the plurality of game cards to a second player; and
in the marking step, marking each spot on each of the plurality of game cards dealt to the second player having the indicia assignment corresponding to the draw indicia.

4. The method of claim 3 wherein one of the first player and second player may determine the winning payout for each of the plurality of ranges.

5. The method of claim 4 further comprising dealing one or more cards to one or more additional players other than the first and second players.

6. The method of claim 3 wherein one of the first player and second player may determine the total number of additional players and the number of cards dealt to each of the additional players.

7. The method of claim 6 wherein the payout percentage is calculated based on the probability of completing the marking of the arrangement of the spots, the total number of cards dealt to the players, and the winning payout.

8. The method of claim 7 wherein the probability of completing the marking of the arrangement of the spots is calculated based on the counted number of draw indicia from the drawing step, the number of spots in the arrangement of the spots, and the total number of draw indicia.

9. The method of claim 8 wherein one of the first player and second player may determine the number of spots in the arrangement of the spots.

10. The method of claim 7 wherein the payout percentage for a range of counted draw indicia is calculated in accordance with:
$$PPD ( m : n ) = \frac{( BP ( n ) - BP ( m - 1 ) )}{TC} * O * PC$$
wherein m represents the upper limit of the counted draw indicia range, n represents the lower limit of the counted draw indicia range, O represents the prize level winning payout, TC represents the total number of cards dealt to the players, PC represents the number of cards dealt to the first or second player, and BP(n) represents the probability of winning a bingo-type game with a count of n draw indicia.

11. The method of claim 10 wherein the probability of winning a bingo-type game with a count of n draw indicia is calculated in accordance with:
$$BP ( D ) = \frac{( D ) !}{( D - W ) !} \frac{( T - W ) !}{T !}$$
wherein D represents the count of draw indicia to win a bingo game, W represents the number of spots in the arrangement of spots, and T represents the total number of draw indicia.

12. The method of claim 11 wherein one of the first player and second player may determine one or more of the following variables comprising:
W, O, PC, TC
wherein W represents the number of spots in the arrangement of spots, O represents the prize level winning payout, PC represents the number of cards dealt to the first or second player, and TC represents the total number of cards dealt to the players.

13. The method of claim 3 wherein the bingo-type game is an electronic bingo-type game.

14. The method of claim 13 wherein one of the first player and second player is a virtual player.

15. The method of claim 13 wherein the first and second players are networked players.

16. The method of claim 2 wherein at least one prize level is a progressive jackpot prize level.

17. An electronic bingo-type gaming system comprising:
one or more microprocessors;
a display having a first region operable for displaying a plurality of game cards with win spots and assigned indicia, and a second region operable for displaying a random sequence of indicia;
a player interface for initiating game play and selecting game options; and
a program operable with the one or more microprocessors for generating the plurality of game cards, generating a random sequence of drawn balls, and marking assigned indicia on each of the plurality of game cards corresponding to the random sequence of indicia.

18. The electronic bingo-type gaming system of claim 17 wherein the player interface comprises a touch-sensitive screen.

19. The electronic bingo-type gaming system of claim 17 wherein the game options selectable from the player interface comprise:
the number of the win spots, the arrangement of the win spots, the number of player cards, the number of opponents, the number of cards per each opponent, and the prize level winning payout.

20. The electronic bingo-type gaming system of claim 17 further comprising a second display operable for indicating the winning payout.

21. The electronic bingo-type gaming system of claim 20 wherein the second display comprises slot machine-type reels.

22. An electronic bingo game system comprising:
processing means;
display means for displaying a plurality of game cards with win spots and assigned indicia, and for displaying a random sequence of indicia;
an input means for initiating game play and selecting game options; and
a program running on the processing means for generating the plurality of game cards, generating a random sequence of drawn balls, and marking assigned indicia on each of the plurality of game cards corresponding to the random sequence of indicia.
